(19) United States
(12) Patent Application Publication
(10) Pub. No.: US 2011/0247398 A1
(43) Pub. Date: Oct. 13, 2011

(54) AIR VENT COVER FOR USE IN TESTING AIR LEAKAGE OF AN AIR DUCT SYSTEM

(76) Inventor: Richard Corey Breed, Austin, TX (US)

(21) Appl. No.: 12/757,397

(22) Filed: Apr. 9, 2010

(51) Int. Cl. G01M 3/28

(52) U.S. Cl. 73/40.5 R

(57) ABSTRACT

The present invention discloses an air vent cover for use in testing air leakage of an air duct system. The air vent cover includes a cover portion shaped to define a hollow cavity for enclosing an air vent. The air vent has a grill adjacent to a surface surrounding the air vent, and the grill has one or more louvers. The air vent cover includes a flexible connector extendable from the cover portion through the hollow cavity to the air vent. The flexible connector is removeably attachable to at least one of the louvers on the grill of the air vent. The flexible connector adjusts to secure an edge of the cover portion against a region of the surface surrounding the air vent, thereby creating a seal for inhibiting air flow through the air vent.

### TECHNICAL FIELD

The present invention relates to the field of air vent cover for use in testing air leakage of an air duct system.

### BACKGROUND ART

As the trend to conserve energy continues, more individuals are demanding and more governmental entities are mandating that houses and commercial facilities undergo periodic energy audits. An energy audit is a service where a building structure's energy efficiency is evaluated by a person using professional equipment (such as blower door and infra-red cameras), with the aim to suggest the best ways to improve energy efficiency in heating and cooling the structure.

An energy audit involve recording various characteristics of the building envelope including the walls, ceilings, floors, doors, windows, and skylights. For each of these components the area and resistance to heat flow (R-value) is measured or estimated. The leakage rate or infiltration of air through the building envelope is of concern and is strongly affected by window construction and quality of door seals such as weather stripping. The goal of an audit is to quantify the building's overall thermal performance. The audit may also assess the efficiency, physical condition, and programming of mechanical systems such as the heating, ventilation, air conditioning (HVAC) equipment, and thermostat.

Leaks in an air duct system often account for a large percentage of energy being wasted in a typical home. In a residence, the percentage of air that escapes out of an air duct system due to leaks, on average, is approximately twenty-five percent (25%). Given that in some areas of the country, sixty percent (60%) to seventy percent (70%) of the cost of a household's monthly utilities bill is due to the operation of the HVAC system, air leakage in an air duct system may represent a significant waste of both monetary and energy resources.

Measuring the leakage in an air duct system is generally the most time consuming portion of a home energy audit. In fact, as much as fifty percent (50%) of the time required to perform a home energy audit is consumed in testing air leakage of an air duct system. The majority of that time is spent sealing off the various air vents so that the air duct system can be pressurized or depressurized to measure the air leaks.

Current methods of sealing off the air vents involve the use of a special adhesive tape that adheres to the face of an air vent. There are, however, certain drawbacks to the use of this adhesive tape. Applying and removing the adhesive tape to all of the air vents takes a significant amount of time because the adhesive tape is cumbersome and awkward to use. Commonly, the tape sticks to itself and those pieces have to be thrown away unused. The tape is generally stored in bulky spools that are heavy and difficult to maneuver. When the tape is removed from the spools, it can generate an extremely loud noise that may wake up members of a home that are asleep during the day, such as, for example a baby or elderly person taking a nap, or be disruptive to ongoing business concerns.

Another drawback is that the tape does not provide the best seal possible for the air duct system. Even after the tape is applied to the air vent, air may still enter and leave the air duct system beneath the face of the air vent that touches the wall or ceilings surface because the tape only blocks the openings of the air vent on the face of the air vent. The tape does not block openings between the air vent and surface on which the air vent is installed. An additional drawback occurs when the tape is removed. Because the tape uses a strong adhesive, damage often occurs to the wall, ceiling, or air vent when the tape is removed.

### SUMMARY OF INVENTION

The present invention discloses an improved air vent cover for use in testing air leakage of an air duct system. The air vent cover includes a cover portion shaped to define a hollow cavity for enclosing an air vent. The air vent has a grill adjacent to a surface surrounding the air vent, and the grill has one or more louvers. The air vent cover includes a flexible connector extendable from the cover portion through the hollow cavity to the air vent. The flexible connector is removeably attachable to at least one of the louvers on the grill of the air vent. The flexible connector adjusts to secure an edge of the cover portion against a region of the surface surrounding the air vent, thereby creating a seal for inhibiting air flow through the air vent.

The present invention also discloses a method of testing air leakage of an air duct system. The air duct system includes a plurality of air supply vents. The method includes: sealing the plurality of air supply vents to obstruct the flow of air through the air duct system, including, for at least one of the plurality of air supply vents, removeably attaching with a flexible connector an enclosure to a louver of the one air vent so as to secure an edge of the enclosure against a region of a surface surrounding the air vent; changing air pressure within the air duct system; measuring air leakage during the change in air pressure; recording the measured air leakage; and unsealing the plurality of air supply vents, including detaching the flexible connector from the louver of the one air vent.

### BRIEF DESCRIPTION OF DRAWINGS

The accompanying drawings, which are incorporated in and constitute a part of this specification, illustrate an implementation of apparatus and methods consistent with the present invention and, together with the detailed description, serve to explain advantages and principles consistent with the invention. In the drawings,

FIG. 1 sets forth a drawing illustrating a perspective view of an exemplary air vent cover for use in testing air leakage of an air duct system according to embodiments of the present invention.

FIG. 2 sets forth a drawing illustrating a perspective view of an exemplary air vent cover for use in testing air leakage of an air duct system according to embodiments of the present invention.

FIG. 3A sets forth a drawing illustrating a top view of an exemplary air vent cover for use in testing air leakage of an air duct system according to embodiments of the present invention.

FIG. 3B sets forth a drawing illustrating the cross section A-A from FIG. 3A.

FIG. 4A sets forth a drawing illustrating a top view of an exemplary air vent cover for use in testing air leakage of an air duct system according to embodiments of the present invention.

FIG. 4B sets forth a drawing illustrating the cross section B-B from FIG. 4A.

FIG. 5A sets forth a drawing illustrating a top view of an exemplary air vent cover for use in testing air leakage of an air duct system according to embodiments of the present invention.

FIG. 5B sets forth a drawing illustrating the cross section C-C from FIG. 5A.

FIG. 6A sets forth a drawing illustrating a top view of an exemplary air vent cover (620) for use in testing air leakage of an air duct system according to embodiments of the present invention.

FIG. 6B sets forth a drawing illustrating the cross section D-D from FIG. 6A.

FIG. 7 sets forth a drawing illustrating a portion of a flexible connector in an exemplary air vent cover for use in testing air leakage of an air duct system according to embodiments of the present invention.

FIG. 8 sets forth a flow chart illustrating a method of testing air leakage of an air duct system according to embodiments of the present invention.

### DESCRIPTION OF EMBODIMENTS

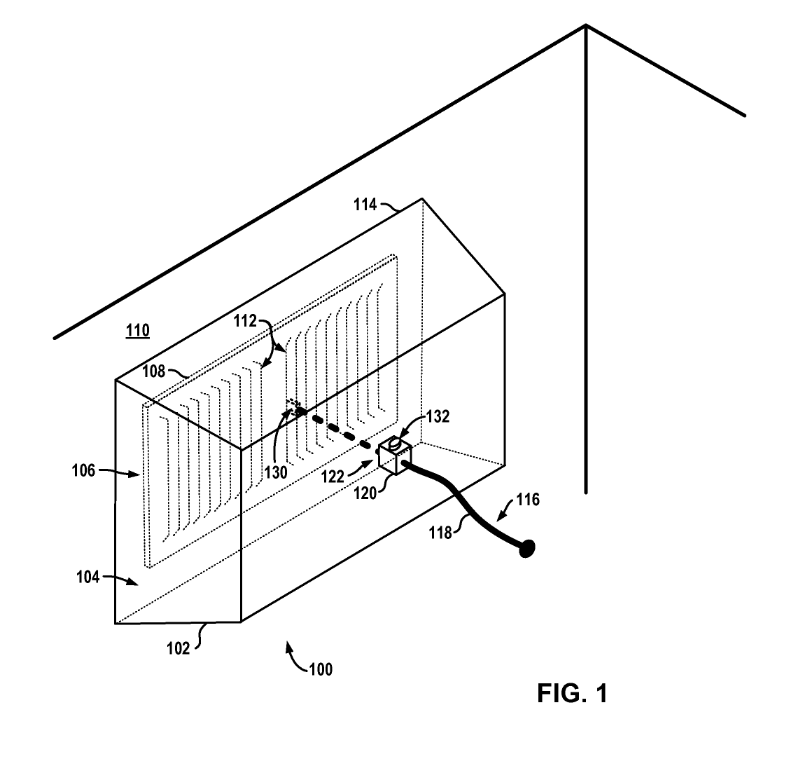

Exemplary embodiments of air vent covers for use in testing air leakage of an air duct system are described herein with reference to the accompanying drawings, beginning with FIG. 1. FIG. 1 sets forth a drawing illustrating a perspective view of an exemplary air vent cover (100) for use in testing air leakage of an air duct system according to embodiments of the present invention. Air duct systems are used in heating, ventilation, and air conditioning (HVAC) to deliver, circulate, or remove air using supply, return, or exhaust airflows. Air duct systems, therefore, are one method of ensuring acceptable indoor air quality as well as thermal comfort.

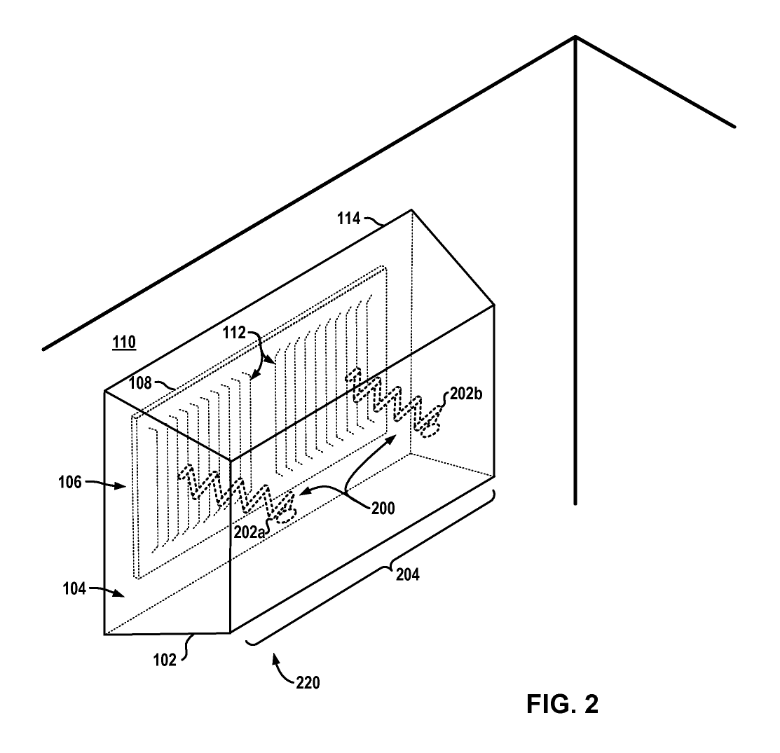

Though air duct systems vary from one installation to another, many air duct system share a common set of components. Air duct systems generally include an air handler unit that may be composed of a blower or fan, heating or cooling elements, filters, humidifier, mixing chamber, heat recovery device, controls, and vibration isolators. In addition, air duct systems typically include a network of plenums and ducts that direct airflow between the air handler unit and various air vents used to supply air to or return air from the spaces served by the air duct system. Readers will note that much of the air vent system is omitted from FIG. 1 and the remaining FIGS. 2-8 for clarity.

In FIG. 1, the air duct system includes an air vent (106). An air vent is an opening, typically covered by a grill, in an air duct system that serves to supply air to or return air from a space served by the air duct system. Those of skill in the art often may refer to an “air vent” as an air diffuser, an air grate, or a terminal unit.

The air vent (106) of FIG. 1 has a grill (108) adjacent to a surface (110) surrounding the air vent (106). In the example of FIG. 1, the surface (110) is the interior wall of a room served by the air duct system. In embodiments of the present invention, however, the surface surrounding an air vent may be any surface of a room or structure, including a wall, floor, ceiling, or any other surface as will occur to those of skill in the art. The grill (108) provides a face for the air vent (106) and may serve a decorative or functional purpose. For example, the grill (108) may include an ornamental design, provide a mechanism for directing airflow, or be used to secure the air vent (106) to the surrounding surface (110).

The grill (108) of FIG. 1 has one or more louvers (112). A louver is a baffle used to direct or control the flow of air through an air vent. A louver may extend beyond the face of the air vent, as in the example of FIG. 1, or may be inset into the face of the air vent. Still further, some louvers may be placed inside the air vent. A louver may be fixed in place or allowed to move through a range of positions. In fact, many air vents are designed with both fixed and moveable louvers. Whether fixed or moveable, a louver may be configured at a slanted angle or perpendicular to the face of the air vent. In the example of FIG. 1, the louvers (112) are fixed in place at slanted angles and are formed as integral components with the grill (108).

In the example of FIG. 1, an air vent cover (100) is placed over the air vent (106) to create a seal for inhibiting air flow through the air vent (106) while testing air leakage of the air duct system. The air may attempt to flow through the air vent (106) due to either pressurization or depressurization of the air duct system during the leak testing process. Systems used to pressurize or depressurize an air duct system are known to those of skill in the art and may include, for example, the Minneapolis Duct Blaster® or the Retrotec Duct Testing Blower System.

The air vent cover (100) of FIG. 1 includes a cover portion (102) shaped to define a hollow cavity (104) for enclosing the air vent (106). The air vent cover (100) of FIG. 1 is composed of a single layer of polyurethane. The air vent cover (100) may be fashioned out of a variety of materials, including but not limited to, polyurethane, plastic, harden rubber, or any other material as will occur to those of skill in the art.

In the example of FIG. 1, the hollow cavity (104) is generally large enough to receive the portion of the air vent (106) extending from the surface (110) into the space served by the air duct system. Typically, the portion of the air vent extending from the surface includes the grill and any levers for changing the position of any moveable louvers.

The cover portion (102) in the example of FIG. 1 is large enough in circumference that the edge (114) of the cover portion (102) surrounds the air vent (106) when placed against the surface (110). In FIG. 1, the cover portion (102) is shaped as a trapezoidal prism. This shape, however, is for example only, and not for limitation. Readers of skill in the art will recognize that the cover portion (102) may be any shape so long as the hollow cavity (104) defined by the cover portion can enclose the portion of the air vent extending from the surface into the surrounding space. Such exemplary shapes may include a hemisphere, cuboid, cone, pyramid, parallelepiped, prism, or any other shape as will occur to those of skill in the art.

The exemplary air vent cover (100) of FIG. 1 also includes a flexible connector (116). The flexible connector (116) extends from the cover portion (102) through the hollow cavity (104) to the air vent (106). In the example of FIG. 1, the flexible connector (116) is removeably attached to one of the louvers (112) on the grill (108) of the air vent (106) using a hook (130). Readers will note that the use of a hook is for example only, not for limitation. Other components for removeably attaching the flexible connector (116) to the louver (112) as will occur to those of skill in the art may also be used such as a clip or other fastener. Preferably, though not required, the flexible connector is configured for easy attachment and detachment using one hand while holding the cover portion with the other hand.

The flexible nature of the flexible connector (116) facilitates quick and easy attachment to and detachment from the air vent (106). A flexible connector provides certain advantages over a rigid connector, which is often used in long-term or permanently installed covers. Rigid connectors, such as those fashioned from a system of nuts and bolts, are cumbersome and more time-consuming to attach and detach because the air vent cover must be precisely placed in the proper orientation for a rigid connector to connect with the air vent. For example, when using a rigid connector made up of a bolt through the air vent cover, typically the air vent cover has to be lined up with the connection point on the air vent. After lining up the air vent cover, however, the air vent cover often blocks or covers the connection point for the rigid connector on the air vent, thereby enhancing the difficulty associated with making the connection between the rigid connector and the air vent. When using a flexible connector, however, there is no requirement that the air vent cover be aligned with the air vent when attaching the connector the air vent because the flexible connector can bend or twist in the manner needed to quickly and easily connect to the air vent.

In the example of FIG. 1, the flexible connector (116) adjusts to secure the edge (114) of the cover portion (102) against a region of the surface (110) surrounding the air vent (106), thereby creating a seal for inhibiting air flow through the air vent (106). Securing the edge (114) of the cover portion (102) against a region of the surface (110) surrounding the air vent (106) rather than securing the edge (114) against the air vent (106) itself prevents airflow from bypassing the air vent cover (100) by escaping through the small space that often exists between the air vent (106) and the surface (110) beneath the grill (108).

The flexible connector (116) of FIG. 1 includes a flexible cord (118) and an adjustable fastener (120) affixed to the cord (118) at a connection point (122) outside of the cover portion (102). In FIG. 1, the adjustable fastener (120) is capable of adjusting the connection point (122) to change an amount of the cord (118) extending into the hollow cavity (104) by pressing the button (132) on the adjustable fastener (120) and sliding the cord (118) through the adjustable fastener (120) to increase or decrease the length of cord (118) extending through the hollow cavity (104). By increasing the length of cord (118) extending through the hollow cavity (104), enough slack is provided in the flexible connector (116) of FIG. 1 to permit fast, easy attachment of the flexible connector (116) to the louvers (112). Then, decreasing the length of cord (118) extending through the hollow cavity (104) allows the edge (114) of the cover portion (104) to be secured against the surface (110) surrounding the grill (108). Conversely, the air vent cover (100) may be easily removed by increasing the length of cord (118) extending through the hollow cavity (104) to provide enough slack in the flexible connector (116) of FIG. 1 to permit fast, easy detachment of the flexible connector (116) from the louvers (112).

For further explanation, FIG. 2 sets forth a drawing illustrating a perspective view of an exemplary air vent cover (220) for use in testing air leakage of an air duct system according to embodiments of the present invention. The exemplary air vent cover (220) of FIG. 2 is similar to the air vent cover (100) of FIG. 1. Specifically, the air vent cover (220) of FIG. 2 includes a cover portion (102) shaped to define a hollow cavity (104) for enclosing an air vent (106). The air vent (106) of FIG. 2 has a grill (108) adjacent to a surface (110) surrounding the air vent. The grill (108) of FIG. 2 has various louvers (112) for ornamental or functional purposes.

In the example of FIG. 2, the air vent cover (220) includes flexible connectors (200) extendable from the cover portion (102) through the hollow cavity (104) to the air vent (106). The flexible connectors (200) of FIG. 2 are removeably attachable to two of the louvers (112) on the grill (108) of the air vent (106). In the example of FIG. 2, each flexible connector (200) includes a spring (202). A first end of each spring (202) is attached to a central region (204) of the cover portion (102). Each spring (202) of FIG. 2 may be attached by molding a socket for holding the spring (202) on the inner side of the cover portion (102), gluing or bonding the spring (202) to the cover portion (102) or in any other manner as will occur to those of skill in the art. A second end of each spring (202) of FIG. 2 is removeably attachable to a louver (112) on the grill (108) of the air vent (106). Each spring (202) may removeably attach to one of the louvers (112) on the grill (108) of the air vent (106) using a hook, a clip, or other fastener as will occur to those of skill in the art (130).

The flexible connectors (200) of FIG. 2 adjust to secure an edge (114) of the cover portion (102) against a region of the surface (110) surrounding the air vent (106), thereby creating a seal for inhibiting air flow through the air vent (106). In the example of FIG. 2, the flexible connectors (200) adjust to secure the edge (114) as the springs (202) compress along their longitudinal axis. To remove the air vent cover (220), an operator may pull the cover portion (220) away from the surface (110), thereby stretching the springs (202) along their longitudinal axis. The operator may then reach with one hand and disconnect each of the springs from the louvers (112) in the grill (108).

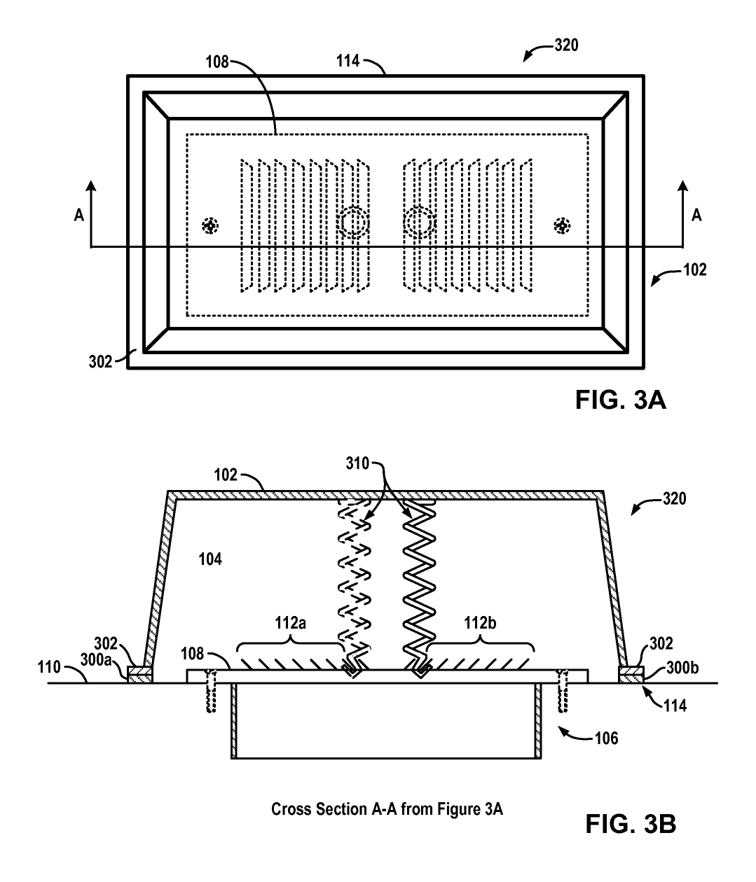

FIGS. 3-6 depict embodiments of various configurations of the flexible connector that secures an exemplary air vent cover against a surface surrounding an air vent. FIG. 3A sets forth a drawing illustrating a top view of an exemplary air vent cover (320) for use in testing air leakage of an air duct system according to embodiments of the present invention. FIG. 3B sets forth a drawing illustrating the cross section A-A from FIG. 3A.

The exemplary air vent cover (320) of FIG. 3 is similar to the air vent cover (220) of FIG. 2. Specifically, the air vent cover (320) of FIG. 3 includes a cover portion (102) shaped to define a hollow cavity (104) for enclosing an air vent (106). The air vent (106) of FIG. 3 has a grill (108) adjacent to a surface (110) surrounding the air vent. The grill (108) of FIG. 3 has various louvers (112) for ornamental or functional purposes.

In the example of FIG. 3, the air vent cover (320) includes flexible connectors (310) extendable from the cover portion (102) through the hollow cavity (104) to the air vent (106). The flexible connectors (310) of FIG. 3 are removeably attachable to the louvers (112) on the grill (108) of the air vent (106). In the example of FIG. 3, each flexible connector (310) is implemented as a spring. A first end of each flexible connector (310) is attached to a central region (204) of the cover portion (102), and a second end of each flexible connector (310) of FIG. 3 is removeably attachable to a louver (112) on the grill (108) of the air vent (106) in the manner similar to that described above with reference to FIG. 2.

The flexible connectors (310) of FIG. 3 adjust to secure an edge (114) of the cover portion (102) against a region of the surface (110) surrounding the air vent (106), thereby creating a seal for inhibiting air flow through the air vent (106). In the example of FIG. 3, the flexible connectors (310) adjust to secure the edge (114) as the springs compress along their longitudinal axis. To remove the air vent cover (320), an operator may pull the cover portion (102) away from the surface (110), thereby stretching the springs (202) along their longitudinal axis. The operator may then reach with one hand and disconnect each of the springs from the louvers (112) in the grill (108).

In the example FIG. 3, the edge (114) of the cover portion (102) includes a flange (302) extending along a circumference of the cover portion (102) closest to the surface (110). The flange (302) of FIG. 3 provides additional surface area to touch the surface (110), which may enhance the ability of the air vent cover (320) to seal against the surface (110). The flange (302) of FIG. 3 may be integrally formed as part of the remaining cover portion (102) or may be formed separately from the remaining cover portion (102) and subsequently attached or bonded to the remaining cover portion (102).

The exemplary cover portion (102) of FIG. 3 also includes a gasket (300) along the edge (114) of the cover portion (102). A gasket is a mechanical seal that fills the space between two mating surfaces. Gaskets allow “less-than-perfect' mating surfaces to seal by filling in irregularities of the mating surfaces. For example, the gasket (300) of FIG. 3 may help the air vent cover (320) seal with a rough surface such as an interior ceiling or wall with a popcorn texture or other rough texture. In this manner, a gasket blocks the flow of air between the inside and outside of the air vent cover (320) while under compression.

The gasket (300) of FIG. 3 may be formed from a variety of materials as will occur to those of skill in the art, including, for example, foam, rubber, nylon, or plastic. When formed from material such as foam, readers will note that there are two types of foam that could be used to create a gasket according to embodiments of the present invention—open-cell foam and closed-cell foam.

In open-cell foam, the cell walls, or surfaces of the bubbles, are broken and air fills all of the spaces in the material. In this manner, open-cell foam creates a permeable barrier that may allow air to flow through it when uncompressed. When compressed, however, the open-cell foam may provide enough of a barrier to serve as a seal. The open-cell nature makes the foam soft or weak, as if it were made of broken balloons or soft toy rubber balls. The insulation value of this foam is related to the insulation value of the calm air inside the matrix of broken cells.

In closed-cell foam, most of the cells or bubbles in the foam are not broken; they resemble inflated balloons or soccer balls, piled together in a compact configuration. This makes the closed-cell foam strong or rigid because the bubbles are strong enough to withstand high-pressure. Although closed-cell foam is rigid, it has varying degrees of hardness, depending on its density. Because the cell walls of closed-cell foam are not generally broken, closed-cell foam provides greater resistance to air leakage than that of open-celled foam.

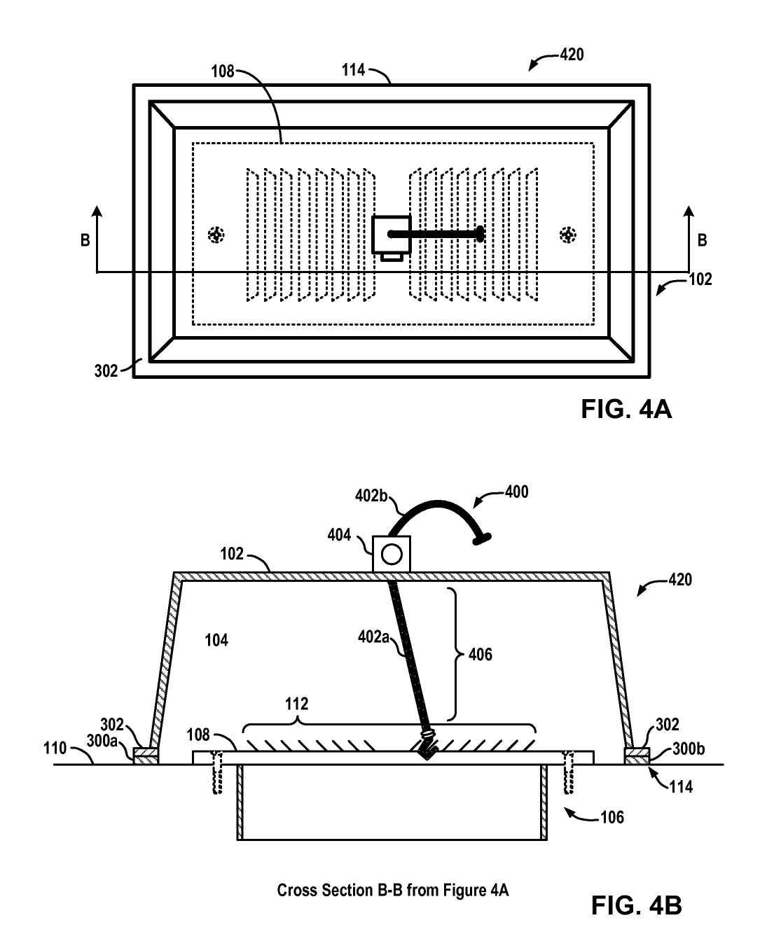

FIG. 4A sets forth a drawing illustrating a top view of an exemplary air vent cover (420) for use in testing air leakage of an air duct system according to embodiments of the present invention. FIG. 4B sets forth a drawing illustrating the cross section B-B from FIG. 4A.

The exemplary air vent cover (420) of FIG. 4 is similar to the air vent cover (220) of FIG. 1. Specifically, the air vent cover (420) of FIG. 4 includes a cover portion (102) shaped to define a hollow cavity (104) for enclosing an air vent (106). The air vent (106) of FIG. 4 has a grill (108) adjacent to a surface (110) surrounding the air vent. The grill (108) of FIG. 4 has various louvers (112) for ornamental or functional purposes.

In the example of FIG. 4, the air vent cover (420) includes a flexible connector (400) extendable from the cover portion (102) through the hollow cavity (104) to the air vent (106). The flexible connector (400) of FIG. 4 is removeably attachable to the louvers (112) on the grill (108) of the air vent (106). In the example of FIG. 4, the flexible connector (400) of the air vent cover (420) includes a cord (402) and an adjustable fastener (404). The adjustable fastener (404) of FIG. 4 is affixed to the cord (402) at a connection point outside of the cover portion (102). The adjustable fastener (404) of FIG. 4 is capable of adjusting the connection point to change an amount (406) of the cord (402) extending into the hollow cavity (104).

The flexible connector (400) of FIG. 4 adjusts to secure an edge (114) of the cover portion (102) against a region of the surface (110) surrounding the air vent (106), thereby creating a seal for inhibiting air flow through the air vent (106). Similar to FIG. 3, the edge (114) of the cover portion (102) in FIG. 4 includes a flange (302) extending along a circumference of the cover portion (102) and a gasket (300) to facilitate the seal between the air vent cover (420) and the surface (110).

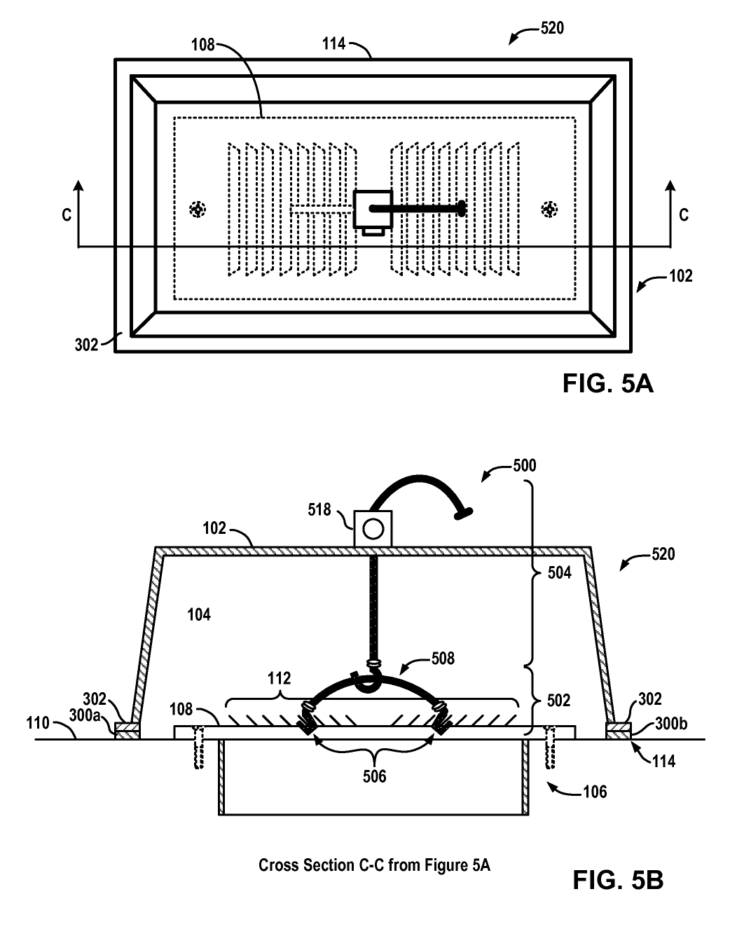

FIG. 5A sets forth a drawing illustrating a top view of an exemplary air vent cover (520) for use in testing air leakage of an air duct system according to embodiments of the present invention. FIG. 5B sets forth a drawing illustrating the cross section C-C from FIG. 5A.

The exemplary air vent cover (520) of FIG. 5 is similar to the air vent covers (100, 220) of FIGS. 1 and 2. Specifically, the air vent cover (520) of FIG. 5 includes a cover portion (102) shaped to define a hollow cavity (104) for enclosing an air vent (106). The air vent (106) of FIG. 5 has a grill (108) adjacent to a surface (110) surrounding the air vent. The grill (108) of FIG. 5 has various louvers (112) for ornamental or functional purposes.

In the example of FIG. 5, the air vent cover (520) includes a flexible connector (500) extendable from the cover portion (102) through the hollow cavity (104) to the air vent (106). The flexible connector (500) of FIG. 5 is removeably attachable to the louvers (112) on the grill (108) of the air vent (106). In the example of FIG. 5, the flexible connector (500) of the air vent cover (520) includes a first segment (502) and a second segment (504). The first segment (502) has two or more louver connectors (506) and a region (508) for connecting the second segment (504) to the first segment (502). Each of the louver connectors (506) connects the first segment (502) to one or more of the louvers (112). In this manner, when the flexible connector (500) of FIG. 5 is adjusted to seal the cover portion (102) to the surface (110), the static forces between the air vent (106) and the air vent cover (520) are more evenly spread across the grill (108) of the air vent (106). In the example of FIG. 5, each segment (502, 504) may be composed of rubber, plastic, nylon, bungee material, or any other material as will occur to those of skill in the art.

The air vent cover (520) of FIG. 5 seals with the surface (110) in much the same way as the air vent cover (420) of FIG. 4. The flexible connector (500) includes an adjustable fastener (518). The adjustable fastener (518) of FIG. 5 is affixed to the second segment (504) at a connection point outside of the cover portion (102). The adjustable fastener (518) of FIG. 5 is capable of adjusting the connection point to change an amount of the second segment (504) extending into the hollow cavity (104).

The flexible connector (500) of FIG. 5 adjusts to secure an edge (114) of the cover portion (102) against a region of the surface (110) surrounding the air vent (106), thereby creating a seal for inhibiting air flow through the air vent (106). Similar to FIGS. 3 and 4, the edge (114) of the cover portion (102) in FIG. 5 includes a flange (302) extending along a circumference of the cover portion (102) and a gasket (300) to facilitate the seal between the air vent cover (520) and the surface (110).

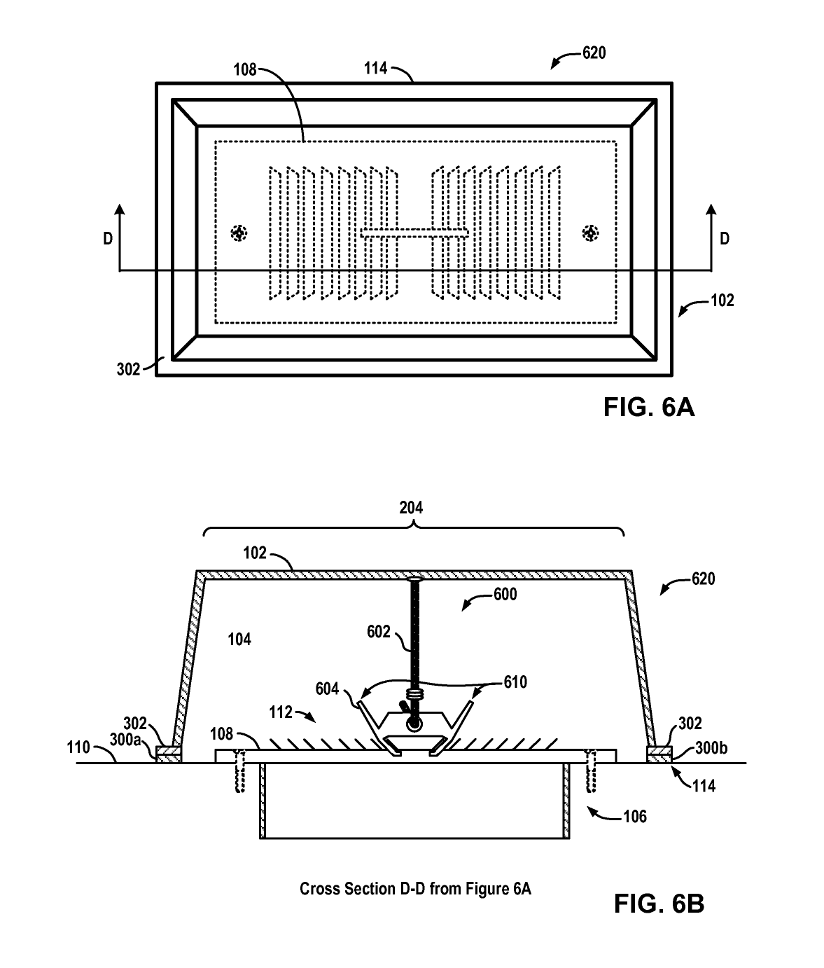

FIG. 6A sets forth a drawing illustrating a top view of an exemplary air vent cover (620) for use in testing air leakage of an air duct system according to embodiments of the present invention. FIG. 6B sets forth a drawing illustrating the cross section D-D from FIG. 6A.

The exemplary air vent cover (620) of FIG. 6 is similar to the air vent covers (100, 220) of FIGS. 1 and 2. Specifically, the air vent cover (620) of FIG. 6 includes a cover portion (102) shaped to define a hollow cavity (104) for enclosing an air vent (106). The air vent (106) of FIG. 6 has a grill (108) adjacent to a surface (110) surrounding the air vent. The grill (108) of FIG. 6 has various louvers (112) for ornamental or functional purposes.

In the example of FIG. 6, the air vent cover (620) includes a flexible connector (600) extendable from the cover portion (102) through the hollow cavity (104) to the air vent (106). The flexible connector (600) of FIG. 6 is removeably attachable to the louvers (112) on the grill (108) of the air vent (106). In the example of FIG. 6, the flexible connector (600) includes an expandable cord (602). An example of an expandable cord that may be useful in air vent covers according to embodiments of the present invention may include a bungee cord or similar cords as will occur to those of skill in the art. A first end of the expandable cord (602) is attached to a central region (204) of the cover portion (102). A second end of the expandable cord (602) is removeably attachable to at least one of the louvers (112) on the grill (108) of the air vent (106). In FIG. 6, the expandable cord (600) may attach directly to the louvers or through some other device such as a clip or another segment of the flexible connector used to distribute the static forces across the grill (108) of the air vent (106).

In the example of FIG. 6, the flexible connector (600) includes a clip (604) for removeably attaching the flexible connector (600) to at least one of the louvers (112) on the grill (108) of the air vent (106). The clip (604) of FIG. 6 is attached and detached by applying pressure to points (610) on the clip. This application of pressure can typically be carried out by an operator using one hand, while the other hand holds the air vent cover (620). After the clip (604) is in place, the operator may expand the expandable cord (602) and attached it to the clip (604). As the expandable cord contracts, pressure is applied to the surface (110) and the air vent cover (620) seals along the edge (114) with the surface (110). In the example of FIG. 6, the clip (604) may be composed of rubber, plastic, polyurethane, or any other material as will occur to those of skill in the art.

The flexible connector (600) of FIG. 6 adjusts to secure an edge (114) of the cover portion (102) against a region of the surface (110) surrounding the air vent (106), thereby creating a seal for inhibiting air flow through the air vent (106). Similar to FIGS. 3, 4, and 5, the edge (114) of the cover portion (102) in FIG. 6 includes a flange (302) extending along a circumference of the cover portion (102) and a gasket (300) to facilitate the seal between the air vent cover (620) and the surface (110).

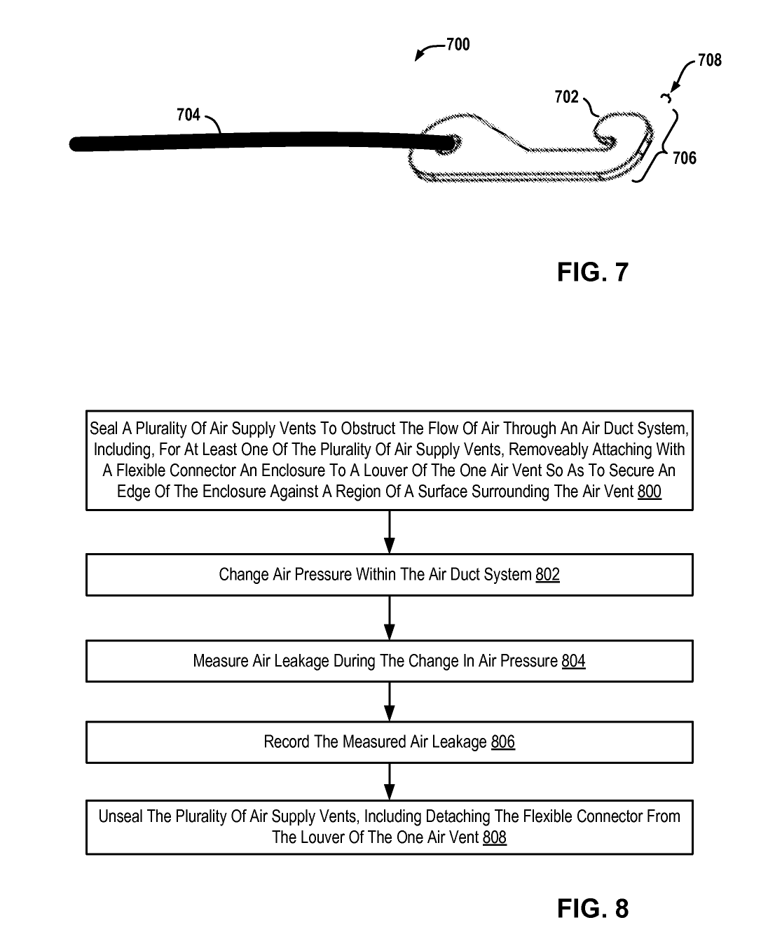

Turning to FIG. 7, FIG. 7 sets forth a drawing illustrating a portion of a flexible connector (700) in an exemplary air vent cover (620) for use in testing air leakage of an air duct system according to embodiments of the present invention. The flexible connector (700) of FIG. 7 includes a cord (704) that extends through the hollow cavity formed by the cover portion of an air vent cover in accordance with embodiments of the present invention.

In the example of FIG. 7, the flexible connector (700) includes a flat hook (702) for removeably attaching the flexible connector (700) to at least one of the louvers on a grill of an air vent. The flat hook (702) of FIG. 7 has a thickness (706) and a width (708) such that the thickness (706) is smaller than the width (708). The small thickness (706) permits the hook (702) to slide easily between the louvers of the air vent, while the larger width (708) provides structural strength. This configuration also makes it easier for an operator to hold and manipulate the hook (702) with one hand.

The flat hook (702) in the example of FIG. 7 is made of flexible material that allows the hook (702) to bend. The flexible nature of the flat hook (702), combined with the flexible nature of the flexible connector (700) in general, facilitates the sealing ability of the air vent cover over a wider range of positions around the air vent than those provided from the use of rigid material. Such rigid materials might force the air vent cover too far to one side of the air vent, which could hinder the sealing ability of the air vent cover to the surface surrounding the air vent cover. The flexible, flat hook (702) of FIG. 7 may be composed of rubber, plastic, polyurethane, or any other material as will occur to those of skill in the art.

FIG. 8 sets forth a flow chart illustrating a method of testing air leakage of an air duct system according to embodiments of the present invention. The air duct system referenced in FIG. 8 includes a plurality of air supply vents. The method of FIG. 8 includes sealing (800) the plurality of air supply vents to obstruct the flow of air through the air duct system.

Sealing (800) the plurality of air supply vents according to the method of FIG. 8 includes, for at least one of the air supply vents, removeably attaching with a flexible connector an enclosure to a louver of an air vent so as to secure an edge of the enclosure against a region of a surface surrounding the air vent. The edge of the enclosure may include a flange or a gasket to facilitate sealing the enclosure with the surface regardless of the surface texture.

In the example of FIG. 8, removeably attaching an enclosure to a louver with a flexible connector may be carried out using a cord and an adjustable fastener such as those described with reference to FIGS. 1, 4, and 5. Removeably attaching an enclosure to a louver with a flexible connector according to the method of FIG. 8 may also be carried out using one or more springs such as those described with reference to FIGS. 2 and 3. Still further, removeably attaching an enclosure to a louver with a flexible connector according to the method of FIG. 8 may be carried out using an expandable cord such as those described with reference to FIG. 6 or any other method as will occur to those of skill in the art.

The method of FIG. 8 also includes changing (802) air pressure within the air duct system, measuring (804) air leakage during the change in air pressure, and recording (806) the measured air leakage. These steps may be carried out using an air duct pressurization or depressurization system known to those of skill in the art such as, for example, the Minneapolis Duct Blaster® or the Retrotec Duct Testing Blower System.

The method of FIG. 8 also includes unsealing (808) the plurality of air supply vents. Unsealing (808) the plurality of air supply vents according to the method of FIG. 8 includes detaching the flexible connector from the louver of the air vent. Detaching the flexible connector from the louver of the air vent according to the method of FIG. 8 may be carried out by removing a hook, clip, or other fastener from the louver.

While certain exemplary embodiments have been described in details and shown in the accompanying drawings, it is to be understood that such embodiments are merely illustrative of and not devised without departing from the basic scope thereof, which is determined by the claims that follow.

I claim:

1. An air vent cover for use in testing air leakage of an air duct system, the air vent cover comprising:
a cover portion shaped to define a hollow cavity for enclosing an air vent, the air vent having a grill adjacent to a surface surrounding the air vent, the grill having one or more louvers;
a flexible connector extendable from the cover portion through the hollow cavity to the air vent, the flexible connector removeably attachable to at least one of the louvers on the grill of the air vent;
wherein the flexible connector adjusts to secure an edge of the cover portion against a region of the surface surrounding the air vent, thereby creating a seal for inhibiting air flow through the air vent.

2. The air vent cover of claim 1 wherein the cover portion further comprises a gasket along the edge of the cover portion.

3. The air vent cover of claim 1 wherein the edge of the cover portion comprises a flange extending along a circumference of the cover portion.

4. The air vent cover of claim 1 wherein the flexible connector comprises a spring, a first end of the spring attached to a central region of the cover portion, a second end of the spring removeably attachable to at least one of the louvers on the grill of the air vent.

5. The air vent cover of claim 1 wherein the flexible connector comprises a cord and an adjustable fastener affixed to the cord at a connection point outside of the cover portion, the adjustable fastener capable of adjusting the connection point to change an amount of the cord extending into the hollow cavity.

6. The air vent cover of claim 1 wherein the flexible connector comprises an expandable cord, a first end of the expandable cord attached a central region of the cover portion, a second end of the expandable cord removeably attachable to at least one of the louvers on the grill of the air vent.

7. The air vent cover of claim 1 wherein the flexible connector comprises a first segment and a second segment, the first segment having two or more louver connectors and a region for connecting the second segment to the first segment, each of the louver connectors for connecting the first segment to one or more of the louvers.

8. The air vent cover of claim 1 wherein the flexible connector comprises a flat hook for removeably attaching the flexible connector to at least one of the louvers on the grill of the air vent, the flat hook having a thickness and a width, the thickness being smaller than the width.

9. The air vent cover of claim 8 wherein the flat hook is flexible.

10. The air vent cover of claim 1 wherein the flexible connector comprises a clip for removeably attaching the flexible connector to at least one of the louvers on the grill of the air vent.

11. An air vent cover for use in testing air leakage of an air duct system, the air vent cover comprising:
a means for enclosing a region adjacent to an air vent, the air vent having one or more louvers; and
a flexible means for removeably connecting the enclosing means to at least one of the louvers, thereby securing the enclosing means to a surface surrounding the air vent.

12. A method of testing air leakage of an air duct system, the air duct system comprising a plurality of air supply vents, the method comprising:
sealing the plurality of air supply vents to obstruct the flow of air through the air duct system, including, for at least one of the plurality of air supply vents, removeably attaching with a flexible connector an enclosure to a louver of the one air vent so as to secure an edge of the enclosure against a region of a surface surrounding the air vent;
changing air pressure within the air duct system;
measuring air leakage during the change in air pressure;
recording the measured air leakage; and
unsealing the plurality of air supply vents, including detaching the flexible connector from the louver of the one air vent.
